(19) United States
(12) Patent Application Publication
(10) Pub. No.: US 2006/0267960 A1
(43) Pub. Date: Nov. 30, 2006

(54) Method for making touch-control acrylic panels

(75) Inventors: Lun-Feng Liao, Taipei City (TW); Chih-Wei Lu, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/429,142

(22) Filed: May 8, 2006

(30) Foreign Application Priority Data
May 13, 2005 (TW) 094115590

(51) Int. Cl. G09G 5/00

(52) U.S. Cl. 345/173

(57) ABSTRACT

A method for making touch-control acrylic panels, including the following steps: (A) providing an acrylic panel having specific areas; (B) electroplating a metal coating at the back side of the acrylic panel; (C) removing the specific metal coating, together with the acrylic material in contact with the specific metal coating; (D) applying an ink coating at the back side of the acrylic panel; and (E) applying an insulating coating over the ink coating. The touch-control acrylic panels not only can provide a quality feeling of electroplating, but also a function of mirror effect. With a pressure-touch-control switch affixed to the acrylic panel as control buttons, there is no such problem as short circuit in electric conductivity.

### BACKGROUND OF THE INVENTION

1. Field of the Invention

The present invention relates to a method for making touch-control acrylic panels, particularly to a method for making touch-control acrylic panels adapted for plasma televisions and liquid crystal televisions.

2. Description of Related Art

Electric appliances are all equipped with control buttons, such as televisions, video or audio players that are provided with a plurality of control buttons for volume or frequency channel control. Currently control buttons for plasma televisions or liquid crystal televisions are mostly located at the sides or lower edges of the televisions, with acrylic panels for decoration and indication. Such acrylic panels cannot work together with the control buttons for controlling purpose, but the control buttons are provided separately from the acrylic panels, where components are disposed disorderly, making the electric appliances less appealing.

### SUMMARY OF THE INVENTION

The object of the present invention is to provide a method for making touch-control acrylic panels adapted for use with control buttons of electric appliances. The method according to the present invention comprises the following steps: (A) providing an acrylic panel having a front side and a back side, wherein the front side of the acrylic panel is provided with at least one specific area; (B) electroplating a metal coating at the back side of the acrylic panel, therefore forming a specific metal coating at the metal coating corresponding to the specific area of the front side; (C) removing the specific metal coating, together with the acrylic material in contact with the specific metal coating; (D) applying an ink coating at the back side of the acrylic panel; and (E) applying an insulating coating over the ink coating.

The touch-control acrylic panels made according to the present invention not only can provide a quality feeling of electroplating, but also a function of mirror reflection and touch-control panels. With a pressure-touch-control switch affixed to the back side of the acrylic panel, a user can control the volume or frequency channel of plasma televisions or liquid crystal televisions, through pressing on the manipulation symbols located at a button area in the specific area of the acrylic panel, thereby activating the pressure-touch-control switch at the back side of the acrylic panel for controlling volume and frequency channel. There is no such problem as short circuit in electric conductivity with the pressure-touch-control switch affixed to the touch-control acrylic panel.

The method for making touch-control acrylic panels according to the present invention further comprises a step (F) for screen-printing manipulating symbols with such as a white or color ink, or attachment of a sticker or laser-machining manipulating symbols, on the button area at the front side of the acrylic panel. In the button area there are a variety of manipulating symbols for such as volume and frequency channel controls. The touch-control acrylic panels so made will provide a button area with manipulating symbols having such advantages as brightness, good quality and eye pleasing.

Similar effectiveness can be obtained if the step (C) for removing the specific metal coating, according to the present invention, is proceeded after finishing the step (D) for the ink-coating application and the step (E) for the insulating-coating application.

The measure for electroplating according to the present invention can be vacuum sputtering or evaporation, or other equivalent electroplating. The metals to be electroplated can be any of aluminum, copper, zinc, or chromium, which can make the touch-control acrylic panels made according to the present invention have a mirror effect and good quality.

The ink coating according to the present invention can be of opaque materials in black or dark color, and preferably self-dry ink, so that the ink can be dried up under room temperature, without the need of other drying measures, and as such, time and cost can be saved.

Further, the insulating coating according to the present invention can be of carbon, graphite, or other equivalent non-electric-conductive materials, so that the touch-control acrylic panels made according to the present invention can avoid the problem of short circuit when contacting the touch-control acrylic panel with the pressure-touch-control switch.

Other objects, advantages, and novel features of the present invention will become more apparent from the following detailed description when taken in conjunction with the accompanying drawings.

### BRIEF DESCRIPTION OF THE DRAWINGS

FIG. 1 is a block diagram illustrating a method for making touch-control acrylic panels according to a first embodiment of the present invention.

FIG. 2 is an exploded view of a touch-control acrylic panel made according to the first embodiment of the present invention.

FIG. 3 is a schematic view showing the touch-control acrylic panel made according to the first embodiment of the present invention.

FIG. 4 is a cross-sectional view of the touch-control acrylic panel made according to the first embodiment of the present invention.

FIG. 5 is a block diagram illustrating the method for making touch-control acrylic panels according to a second embodiment of the present invention.

FIG. 6 is a cross-sectional view of the touch-control acrylic panel made according to the second embodiment of the present invention.

### DETAILED DESCRIPTION OF THE PREFERRED EMBODIMENTS

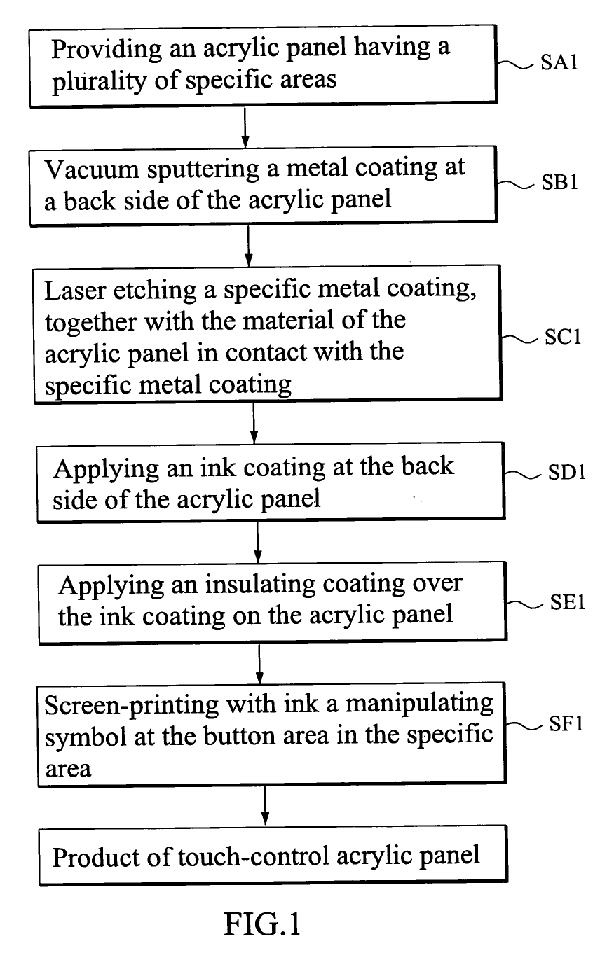

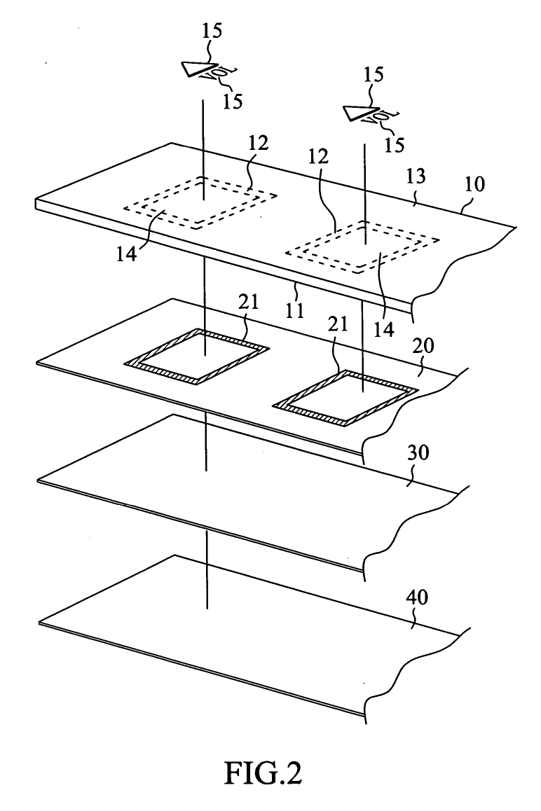

Referring to FIG. 1 and FIG. 2, a touch-control acrylic panel 10 is provided (step SA1), wherein the touch-control acrylic panel 10 includes a back side 11, a front side 13, a plurality of specific areas 12, a plurality of button areas 14 inside each of the specific areas 12. The acrylic panel 10 according to the first embodiment present invention has a thickness of 3 mm. Further, an aluminum coating 20 of a thickness of 1-2 μm is vacuum sputtered on the back side 11 of the acrylic panel 10 (step SB1). Therefore, a specific metal coating 21 is formed on the aluminum coating 20 at a place corresponding to the specific area 12. By virtue of the aluminum coating 20, the acrylic panel 10 made according to the present invention has a merit of mirror effect and good quality.

Further, laser etching is applied to the multiple specific metal coating 21 at the back side 11 of the acrylic panel 10, where laser etching is applied also to the material of the acrylic panel 10 in contact with the specific metal coating 21 (step SC1). Then the back side 11 of the acrylic panel 10 is screen-printed with a black and opaque ink coating 30 (step SD1). The ink coating according to the present embodiment is of self-dried type, and thus can be dried up under room temperature, without the need of other drying measures so as to reduce the step flow and save time and cost.

Then, a carbon insulating coating 40 of a thickness of 15-20 μm is applied on the ink coating 30 (step SE 1). Thereby, when in use, the acrylic panel 10 is assembled together with a pressure-touch-control switch (not shown), there will be no such problem as short circuit in electric conductivity if the acrylic panel 10 contacts with the pressure-touch-control switch, and as a result, a non-electric-contact protection can be obtained.

Finally, button areas 14 at the front side 13 of the acrylic panel 10 are screen-printed with manipulating symbols 15 of white ink (step SF1). Thereby, the acrylic panel 10 made according to the present invention will provide the button area 14 with manipulating symbols 15 in merits of brightness, good quality and eye pleasing.

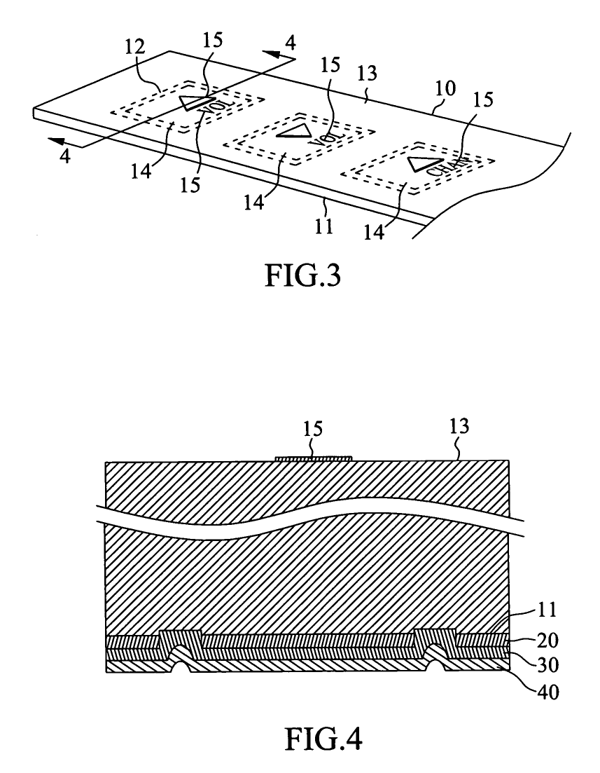

The acrylic panel 10 made according to the present invention has an appearance, shown in FIG. 3 as a touch-control acrylic panel, where the structure of the acrylic panel 10 is shown in FIG. 4 being a cross-sectional view of the touch-control acrylic panel.

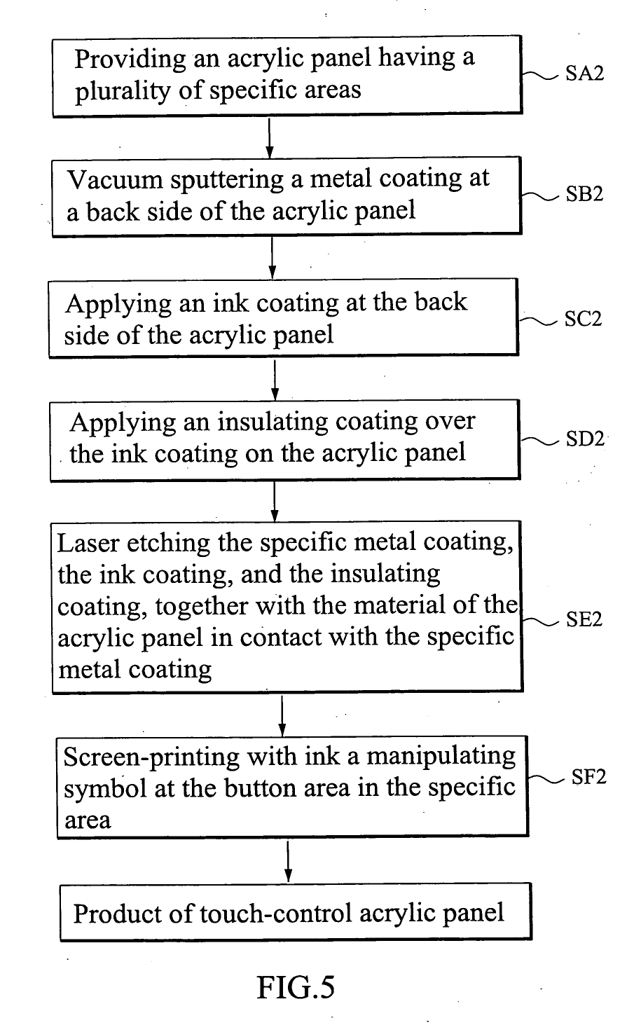

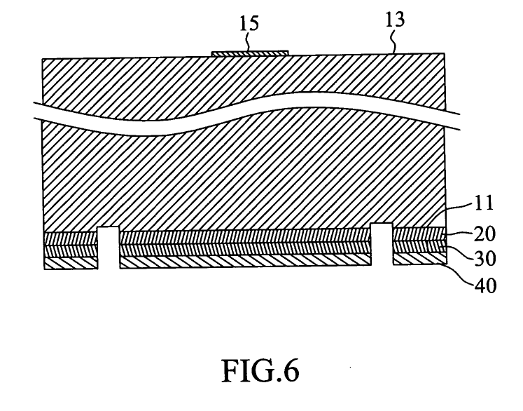

Further, FIG. 5 shows a block diagram illustrating the method for making touch-control acrylic panels according to the second embodiment of the present invention. In this embodiment, removal step (SE2) is proceeded after finishing a step (SC2) for ink-coating application and a step (SD2) for insulating-coating application. An acrylic panel 10, shown in FIG. 6 as a cross-sectional view for a touch-control acrylic panel made according to the second embodiment of the present invention, can also have a similar effectiveness as the touch-control acrylic panel made according to the first embodiment of the present invention. It is clear that illustration on the second embodiment of the present invention take the advantage of convenient understanding by using the same numerical references of illustration on the first embodiment.

Although the present invention has been explained in relation to its preferred embodiments, it is to be understood that many other possible modifications and variations can be made without departing from the scope of the invention as hereinafter claimed.

What is claimed is:

1. A method for making touch-control acrylic panels, comprising the following steps:
(A) providing an acrylic panel having a front side and a back side, and at least one specific area;
(B) electroplating a metal coating at the back side of the acrylic panel, therefore forming a specific metal coating at the metal coating corresponding to the at least one specific area;
(C) removing the at least one specific metal coating, together with the material at the back side of the acrylic panel in contact with the specific metal coating;
(D) applying an ink coating at the back side of the acrylic panel; and
(E) applying an insulating coating over the ink coating.

2. The method as claimed in claim 1, wherein the acrylic panel further includes at least one button area located in the specific area; and wherein the method further comprises a step (F) for noting a manipulating symbol in the at least one button area in the specific area.

3. The method as claimed in claim 2, wherein the measure for noting the manipulating symbol in step (F) relates to a screen-printing.

4. The method as claimed in claim 1, wherein the measure in electroplating the metal coating in step (B) relates to vacuum sputtering.

5. The method as claimed in claim 1, wherein the metal coating in step (B) relates to at least one material selected from the group consisting of aluminum, copper, zinc, and chromium.

6. The method as claimed in claim 1, wherein the measure in removing the metal coating in step (C) relates to laser etching.

7. The method as claimed in claim 1, wherein the ink referred to in step (D) relates to a dark color and opaque ink material.

8. The method as claimed in claim 1, wherein the insulating coating referred to in step (E) relates to at least one material selected from the group consisting of carbon and graphite.

9. A method for making touch-control acrylic panels, comprising the following steps:
(A) providing an acrylic panel having a front side and a back side, and at least one specific area;
(B) electroplating a metal coating at the back side of the acrylic panel, therefore forming a specific metal coating at the metal coating corresponding to the at least one specific area;
(C) applying an ink coating at the back side of the acrylic panel;
(D) applying an insulating coating over the ink coating; and
(E) removing the at least one specific metal coating, together with the ink coating and the insulating coating corresponding to the specific metal coating, and further removing the material at the back side of the acrylic panel in contact with the specific metal coating.

10. The method as claimed in claim 9, wherein the acrylic panel further includes at least one button area located in the specific area; and wherein the method further comprises a step (F) for noting a manipulating symbol in the at least one button area located in the specific area.

11. The method as claimed in claim 10, wherein the measure in noting the manipulating symbol in step (F) relates to a screen-printing.

12. The method as claimed in claim 9, wherein the measure in electroplating the metal coating in step (B) relates to vacuum sputtering.

13. The method as claimed in claim 9, wherein the metal coating in step (B) relates to at least one material selected from the group consisting of aluminum, copper, zinc, and chromium.

14. The method as claimed in claim 9, wherein the ink referred to in step (C) relates to a dark color and opaque ink material.

15. The method as claimed in claim 9, wherein the insulating coating referred to in step (D) relates to at least one material selected from the group consisting of carbon and graphite.

16. The method as claimed in claim 9, wherein the measure in removing the metal coating in step (E) relates to laser etching.
